(19) United States
(12) Patent Application Publication
(10) Pub. No.: US 2020/0295523 A1
(43) Pub. Date: Sep. 17, 2020

(54) LASER LIGHT SOURCE UNIT, ILLUMINATION APPARATUS AND METHOD FOR GENERATING LASER LIGHT

(71) Applicant: HELLA GmbH & Co. KGaA, Lippstadt (DE)

(72) Inventors: Mathias DRUEPPEL, Lippstadt (DE); David DUHME, Lippetal (DE); Kai EHLERT, Bueren (DE); Bernd FISCHER, Altenbeken (DE); Julien HANSEN, Delmenhorst (DE); Marc KAUP, Paderborn (DE); Lukas POERTNER, Bielefeld (DE); Claas TEBRUEGGE, Lippstadt (DE); Benjamin WILLEKE, Paderborn (DE); Jan-Henning WILLRODT, Hamburg (DE)

(73) Assignee: HELLA GmbH & Co. KGaA, Lippstadt (DE)

(21) Appl. No.: 16/887,840

(22) Filed: May 29, 2020

Related U.S. Application Data
(63) Continuation of application No. PCT/EP2018/081865, filed on Nov. 20, 2018.

(30) Foreign Application Priority Data
Nov. 29, 2017 (DE) 10 2017 128 244.0

(51) Int. Cl. H01S 3/08; H01S 3/06; H01S 3/16; F21S 41/16; B60Q 3/60; H01S 3/0941

(52) U.S. Cl. CPC H01S 3/08036; H01S 3/0604; H01S 3/1613; H01S 3/09415; B60Q 3/60; H01S 3/08086; H01S 3/08059; F21S 41/16

(57) ABSTRACT

A laser light source unit for vehicles, with a resonator containing a first end mirror and a second end mirror, between which an active laser medium is arranged, and with a pump device for generating pump radiation, which can be introduced into the resonator via the first end mirror, wherein a rotatable birefringent medium is arranged in the resonator such that, according to a rotation of the birefringent medium, preferred radiation of different wavelengths is stimulated in the active laser medium.

This nonprovisional application is a continuation of International Application No. PCT/EP2018/081865, which was filed on Nov. 20, 2018, and which claims priority to German Patent Application No. 10 2017 128 244.0, which was filed in Germany on Nov. 29, 2017, and which are both herein incorporated by reference.

### BACKGROUND OF THE INVENTION

### Field of the Invention

The invention relates to a laser light source unit, in particular for an illumination apparatus for vehicles, with a resonator containing a first end mirror and a second end mirror, between which an active laser medium is arranged, and with a pump device for generating pump radiation which can be introduced into the resonator via the first end mirror. The invention further relates to an illumination apparatus for vehicles and a method for generating laser light.

### Description of the Background Art

From DE 10 2015 121 693 A1, which is incorporated herein by reference, a laser light source unit for vehicles is known, which has a resonator with a first end mirror and a second end mirror, wherein an active laser medium is arranged between the two end mirrors. Pump radiation is applied to the active laser medium by means of a pump device, wherein the pump radiation enters the resonator through a first end mirror. A second opposite end mirror formed of a plurality of mirror segments which have layer thicknesses such that radiation of a particular wavelength is stimulated in the active laser medium. For example, three mirror segments can be provided, a first mirror segment stimulating blue wavelength radiation, a second mirror segment stimulating green wavelength radiation and a third mirror segment stimulating red wavelength radiation, so that additive color mixing emits a white laser light. By choosing the mirror segments to be on the second end mirror, the emission spectrum of the emitted laser light is defined. The light color can then no longer be varied or changed.

### SUMMARY OF THE INVENTION

It is therefore an object of the present invention to provide a laser light source unit or an illumination apparatus as well as a method for generating laser light, so that coherent and polarized laser light of different light colors can be emitted from a laser cavity.

To achieve this object, the invention in connection is characterized in that a rotatable birefringent medium is arranged in the resonator such that, according to a rotation of the birefringent medium, preferred radiation of different wavelengths is stimulated in the active laser medium.

According to an exemplary embodiment of the invention, a rotatable birefringent medium is arranged integrated in a resonator, so that preferred radiation of a specific wavelength to be stimulated in the active laser medium can be set. The birefringent medium achieves that, in a rotational position of the birefringent medium, only a specific wavelength is in phase and has the same polarization direction after twice the passage through said medium, while the radiation of other wavelengths is phase shifted or has different polarization directions. The preferred radiation and thus the light color of the laser beam to be emitted can be set according to the rotational position of the birefringent medium. According to the rotational position of the birefringent medium, which is preferably rotatable about an optical axis of the laser light source unit, the light color of the laser light to be emitted can be adjusted by selectively adjusting the wavelengths of the preferred radiation. The color emission of the laser light source unit can advantageously vary. According to the rotation of the birefringent medium, monochromatic emission or polychromatic emission can take place. White laser light can be generated, for example, by rotating the birefringent medium at a specific minimum speed, so that the white laser light is generated by additive color mixing.

The birefringent medium can be designed as a birefringent crystal plate, which is arranged inclined to an optical axis of the laser light source unit such, that the radiation directed by the active laser medium toward the second end mirror impinges on the birefringent crystal plate is at a Brewster angle θs. This way, reflection losses can advantageously be minimized.

The pump device can emit pump radiation of a first wavelength that enters the resonator through the first end mirror. The first end mirror and the second end mirror are designed to be highly transmissive for the pump radiation, so that radiation in the first wavelength emerges from the second end mirror or from the light source unit. With respect to preferred radiation with the different wavelengths, which differs from the first wavelength of the pump radiation, the first end mirror and the second end mirror are designed to be highly reflective, so that the preferred radiation of one of these wavelengths can be stimulated in the active laser medium. The setting or selection of the preferred radiation with the specific wavelength is accomplished by the rotational position or rotational speed of the birefringent medium. This advantageously results in additive color mixing between the pump radiation of the first wavelength, on the one hand with the preferred radiation of a second wavelength and/or third wavelength and/or a further wavelength, on the other hand to laser light of a specific light color.

The pump device can have a laser diode which emits pump radiation of a blue wavelength as the first wavelength. The active laser medium can include praseodymium-doped crystal material, in particular praseodymium-doped yttrium lithium fluoride crystal material. The laser medium is selected in such a way that stimulation is carried out with the aid of a light blue wavelength, so that a wide spectrum of different light colors can be emitted by means of appropriate additive color mixing of the stimulated wavelength with the blue wavelength of the laser diode.

In a first rotational position of the birefringent medium, exclusively the preferred radiation of the second wavelength can be stimulated and in a second rotational position of the birefringent medium, exclusively the preferred radiation of the third wavelength can be stimulated. The birefringent medium is thus in a stationary rotational position, which is only changed if a laser beam of a different light color is to be emitted from the second end mirror. The laser light color can be set or adjusted quickly since the birefringent medium only needs to be rotated by an acute angle.

At least one of the end mirrors can be designed to be flat or spherical, both end mirrors of the resonator also able to be shaped as flat or spherical end mirrors. The first end mirror can be flat, and the second end mirror can be spherical. In this way, the end mirrors can be particularly simply adjusted in order to obtain a particularly stable resonator structure, which thereby meets the best reflection requirements.

Also, an illumination apparatus for vehicles is provided. This includes an optical unit which is pre-mounted on the laser light source unit, by means of which a desired light distribution can be set. For example, a low beam distribution or a dynamic high beam distribution with anti-glare segments in the light distribution can be generated to avoid glare from other road users. In particular, the optical unit can have a liquid crystal device, so that it is possible to specifically and precisely produce different, sharply distinguishable light distributions.

Further, radiation within the resonator on the way from the active laser medium and the second end mirror can be transmitted twice through a birefringent medium, with a respective change in the direction of polarization after passing through the birefringent medium, wherein only preferred radiation of a specific wavelength is in phase and has the same polarization direction after twice the passage through the birefringent medium as before twice the passage through the birefringent medium.

The particular advantage of the method according to the invention is that, according to the rotation of a birefringent medium, preferred radiation with a specific wavelength can be defined or set, which is stimulated in the active laser medium and therefore essentially contributes to adjusting the emitted color. This advantageously allows laser light of different colors to be generated solely based on the rotation of the birefringent medium.

White laser light can be generated by rotating the birefringent medium when it exceeds a minimum rotational speed about an optical axis, wherein by additive color mixing, in accordance with the rotational position of the birefringent medium, preferred radiation of different wavelengths and a wavelength of the pump radiation are generated. The birefringent medium can be operated at a constant speed, so that stable white laser light is generated.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic structure of a laser light source unit;

FIG. 2 is a plan view of a circular birefringent medium with an illustration of preferred radiation of different wavelengths; and

FIG. 3 is an emission spectrum of the emitted laser light of white light color, wherein the birefringent medium is operated at a minimum speed.

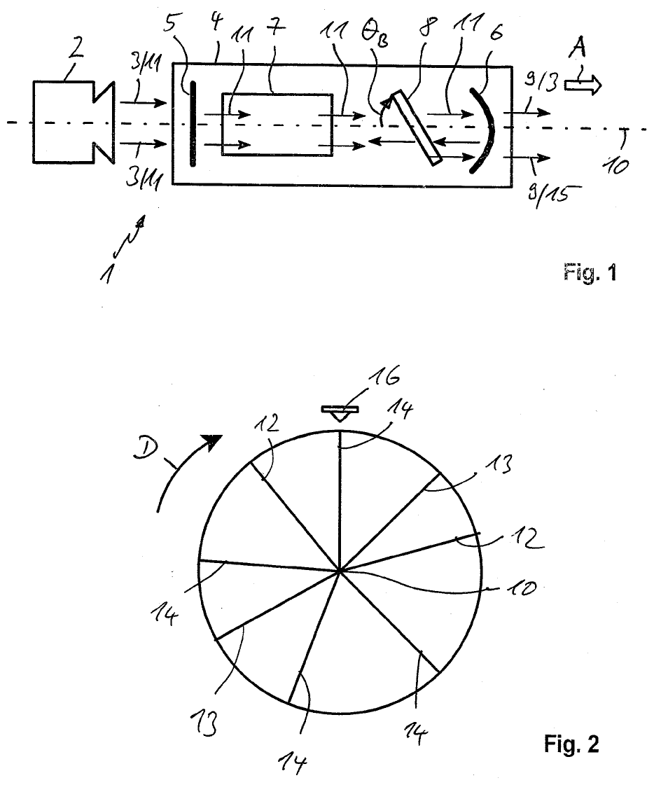

### DETAILED DESCRIPTION

A laser light source unit 1 according to the invention can be used in illumination apparatuses for vehicles, for example as headlights or for example as interior lighting in vehicles. Alternatively, the laser light source unit 1 can also be used in other lights for other purposes.

The laser light source unit 1 includes a pump device 2 for generating pump radiation 3, and a resonator 4. The resonator 4 has a first end mirror 5 on a side facing the pump device 2 and a second end mirror 6 on a side facing away from the pump device 2. Between the first end mirror 5 and the second end mirror 6 of the resonator 4, an active laser medium 7 and a birefringent medium 8 are arranged. In the present exemplary embodiment, the active laser medium 7 is arranged between the first end mirror 5 and the birefringent medium 8. The birefringent medium 8 is arranged between the active laser medium 7 and the second end mirror 6.

The first end mirror 5 serves as an input mirror for the pump radiation 3. The second end mirror 6 serves as an output mirror for emitting laser light 9 in a radiation direction A.

Along an optical axis 10 of the laser light source unit 1, the pump device 2, the first end mirror 5, the active laser medium 7, the birefringent medium 8 and the second end mirror 6 are thus arranged one behind the other.

The birefringent medium 8 can also be arranged in the radiation direction A behind the active laser medium 7 so that it is positioned between the active laser medium 7 and the first end mirror.

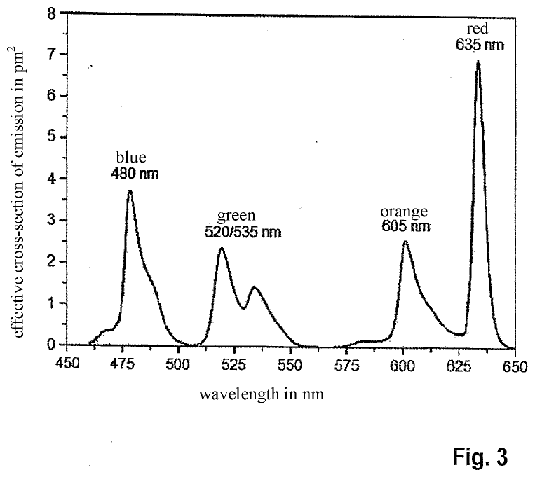

The pump device 2 comprises a laser diode, which emits pump radiation 3 of a first wavelength 11, namely a blue wavelength. For example, FIG. 3 shows the emission spectrum of the white laser light 9, wherein in addition to the first wavelength 11 (blue), a second wavelength 12 (green wavelength), a third wavelength 13 (orange wavelength) and a fourth wavelength 14 (red wavelength) are specified. The term wavelength used here also stands synonymously for wavelength ranges which comprise several wavelengths for a specific light color, as is shown, for example, by the emission spectrum of the laser medium 7 shown in FIG. 3.

The active laser medium 7 is designed as a praseodymium-doped crystal material, for example praseodymium-doped yttrium lithium fluoride crystal material (Pr 3+:YLF) and emits an emission spectrum. The active laser medium can also be formed of another crystal material. The Pr:YLF crystal should be used in particular to generate green and red wavelengths.

The first end mirror 5 and the second end mirror 6 are designed to be highly transmissive for the pump radiation 3 of the first wavelength 11. The transmittance for the first wavelength 11 is preferably 100% or just below 100% (close to 100%).

The first end mirror 5 is highly reflective for the second wavelength 12 and/or third wavelength 13 and/or fourth wavelength 14 and/or for a further wavelength which is different from the first wavelength 11. The first end mirror 5 preferably has a degree of reflection of 100% or just below 100%. The second end mirror 6 is partially transmissive and/or partially reflective for the second wavelength 12 and/or third wavelength 13 and/or fourth wavelength 14 and/or for a further wavelength that differs from the first wavelength 11. For this purpose, the second end mirror 6 preferably has a degree of reflection in a range from 96% to 100%. The degree of reflection of the second end mirror 6 for the second wavelength 12, third wavelength 13, fourth wavelength 14 and/or further wavelengths different from the first wavelength 11 is smaller than in the first end mirror 5, since radiation of the second wavelength 12 and/or the third wavelength 13 and/or fourth wavelength 14 must be coupled out of the second end mirror 6.

The first end mirror 5 is preferably designed as a flat end mirror and the second end mirror 6 preferably as a spherical mirror. As a result, adjustment can be simplified and the resonator 4 can be designed in a stable manner.

The birefringent medium 8 is provided for color control of the laser light 9 emitted by the laser light source unit 1. Said medium is produced as a birefringent crystal plate, preferably made of a silicon material. The birefringent crystal plate 8 has two parallel flat sides at which radiations enter and exit. The birefringent crystal plate 8 is arranged inclined at a Brewster angle θs to the optical axis 10, so that the radiation arriving from the active laser medium 7 strikes the birefringent crystal plate 8 at the Brewster angle θs. The Brewster angle θs is preferably optimized for the green wavelength 12, so that the blue wavelength 11 and the red wavelength 14 can also strike the crystal plate 8 at an angle close to the Brewster angle θs. This way, unwanted light losses can be minimized for a relatively wide wavelength range.

The birefringent medium 8 is thus arranged inclined and not perpendicular to the optical rule axis 10. The birefringent medium 8 is rotatably supported about the optical axis 10.

According to the rotational position of the birefringent medium 8, preferred radiation 15 can be set with a specific second wavelength 12 or third wavelength 13 or fourth wavelength 14, which in each case is in phase and has the same polarization direction after twice the passage through the birefringent medium 8. If the birefringent medium 8, for example, is brought to a rotational position in which the fourth wavelength 14 (red wavelength) is brought into an active position 16 according to FIG. 2, the preferred radiation 15 is exclusively formed by the red wavelength 14. This means that the red wavelength 14 is stimulated or amplified in the active laser medium 7, while radiation of another wavelength, for example green wavelength 12, orange wavelength 13, is not stimulated. The radiation of the green wavelength 12 and the orange wavelength 13 formed back in the direction of the active laser medium 7, which the birefringent medium 8 transmitted starting from the active laser medium 7, which was then reflected at the second end mirror 6 and which then again the birefringent medium 8 transmitted in the direction of the active laser medium 7, is not in phase and does not have the same polarization direction as the radiation of the green wavelength 12 or the orange wavelength 13 entering from the active laser medium 7 into the birefringent medium. The birefringent medium 8 has the ability that, having passed through the latter twice, only the preferred radiation 15 of a specific wavelength 12, 13, 14 is in phase and has the same polarization direction, but not the other radiation. Only the preferred radiation 15 is stimulated in the active laser medium 7, while the radiation of other wavelengths is not stimulated.

According to the rotational position of the birefringent medium 8, the active laser medium 7 can thus be stimulated with a specific wavelength 12, 13, 14. This preferred radiation 15 with the determined green wavelength 12 or orange wavelength 13 or red wavelength 14 is then additively mixed with the pump radiation 3 of blue wavelength 11 to obtain laser light 9 of a light color thereby determined, which is emitted by the laser light source unit 1 in the radiation direction A.

If the birefringent medium 8 is rotated continuously in one rotational direction D at a speed which is greater than or equal to a minimum speed, preferred radiation 15 of a green wavelength 12, of an orange wavelength 13 and of a red wavelength 14 can be generated in short time intervals, so that laser light 9 of white light color is emitted by additive color mixing with the pump radiation 3 of the blue wavelength 11. The emission spectrum according to FIG. 3 includes this white laser light 9. The minimum speed of the birefringent medium 8 depends on the perceptive ability of the human eye.

A setting device is coupled to the birefringent medium 8 so that a defined angle of rotation and/or a specific speed can be set for the birefringent medium 8.

An optical unit for forming the illumination apparatus can be arranged in the radiation direction A in front of the laser light source unit 1. The optical unit has, for example, a liquid crystal panel with a number of individually controllable pixels arranged in a matrix. By controlling the pixels, a predetermined light distribution, for example a low beam distribution, can be set. For this purpose, the pixels of the liquid crystal panel are imaged into the area in front of the vehicle via a downstream lens unit. If necessary, a traffic area detection unit can be provided, which provides sensor data about the presence and location of another traffic object in the area in front of the vehicle. According to the current position of this traffic object, the pixels of the liquid crystal panel can then be controlled so that the area of the generated light distribution in which the traffic object is located is not illuminated and thus a glare-free area of the light distribution is generated. This glare-free area can be tracked to the changed relative position of the traffic object with respect to the vehicle, so that the entire area in front of the vehicle is illuminated, with the exception of the glare-free area in which the traffic object is currently located (glare-free high beam distribution).

A further lens device for expanding the laser light 9 emitted by the laser light source unit 1 is preferably provided in the radiation direction A behind the liquid crystal panel.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A laser light source unit for an illumination apparatus for vehicles, the laser light source comprising:
a resonator having a first end mirror and a second end mirror;
an active medium arranged between the first end mirror and the second end mirror;
a pump to generate pump radiation that is adapted to be introduced into the resonator via the first end mirror; and
a rotatable birefringent medium arranged in the resonator such that, according to a rotation of the birefringent medium, preferred radiation having different wavelengths is stimulated in the active laser medium.

2. The laser light source unit according to claim 1, wherein the birefringent medium is formed such that at twice the passage through the birefringent medium, exclusively the preferred radiation with a specific wavelength has phase balance and a substantially identical polarization direction, and wherein the preferred radiation with the particular wavelength is in phase and has the same polarization direction before and after twice the passage through the birefringent medium.

3. The laser light source unit according to claim 1, wherein the birefringent medium is designed as a birefringent plate which is arranged at a Brewster angle to an optical axis of the active laser medium.

4. The laser light source unit according to claim 1, wherein the pump device is designed such that the pump device radiates pump radiation of a first wavelength, wherein the first end mirror and the second end mirror are designed to be highly transmissive for the pump radiation of the first wavelength, wherein the first end mirror is designed to be highly reflective for the preferred radiation of a second wavelength and/or a third wavelength and/or a fourth wavelength, and wherein the second end mirror is designed to be partially transmissive and/or partially reflective for the preferred radiation of the second wavelength and/or the third wavelength and/or the fourth wavelength.

5. The laser light source unit according to claim 4, wherein, according to the rotational position of the birefringent medium, the laser light that is coupled out by the second end mirror corresponds to an additive color mixture of the pump radiation of the first wavelength and the preferred radiation of the second wavelength and/or the third wavelength and/or the fourth wavelength.

6. The laser light source unit according to claim 1, wherein the pump device comprises a laser diode for emitting the pump radiation in a blue wavelength as a first wavelength, and wherein the active laser medium includes a praseodymium-doped crystal material.

7. The laser light source unit according to claim 1, wherein the birefringent medium is assigned a setting device for the rotation of the former about the optical axis with a constant speed, so that the preferred radiation of a plurality of wavelengths of the pump radiation of the first wavelength is superimposed on the emitting laser light.

8. The laser light source unit according to claim 1, wherein the first end mirror is flat and the second end mirror of the resonator is spherical.

9. An illumination apparatus for vehicles comprising:
a laser light source unit according to claim 1; and
a radiation direction of a same upstream optical unit for generating a predetermined distribution of light.

10. A method for generating laser light, the method comprising:
introducing pump radiation from an outside into an active laser medium which is arranged between two end mirrors and is coupled out at one of the end mirrors as laser light; and
transmitting radiation within the resonator on the way between the active laser medium and the second end mirror, passed twice through a birefringent medium, each with a change in the polarization direction after passage through the birefringent medium,
wherein after twice the passage through the birefringent medium, exclusively preferred radiation of a specific wavelength is in phase and has the same polarization direction as before twice the passage through the birefringent medium.

11. The method according to claim 10, wherein the birefringent medium is rotated at a speed about the optical axis, which is greater than a minimum speed, so that laser light of a white color is generated by the additive color mixing of wavelengths of the preferred radiation stimulated selectively in the different rotational positions of the birefringent medium and the pump radiation introduced into the active laser medium from the outside.
